(19) United States
(12) Patent Application Publication
(10) Pub. No.: US 2016/0338141 A1
(43) Pub. Date: Nov. 17, 2016

(54) EXCLUDING THE MEASUREMENT GAP DURATION FROM AN INACTIVITY TIMER PERIOD

(71) Applicant: QUALCOMM Incorporated, San Diego, CA (US)

(72) Inventors: Mohammed TAWASHI, San Diego, CA (US); Vinesh Kisan Kaviskar, San Diego, CA (US); Deepak SHASTRY RAVISHANKAR, Frankfurt (DE); Deepak KRISHNAMOORTHI, San Diego, CA (US)

(21) Appl. No.: 14/863,952

(22) Filed: Sep. 24, 2015

Related U.S. Application Data
(60) Provisional application No. 62/161,161, filed on May 13, 2015.

(51) Int. Cl. H04W 76/04; H04W 28/02; H04W 24/08

(52) U.S. Cl. CPC H04W 76/048; H04W 24/08; H04W 28/0278

(57) ABSTRACT

Certain aspects of the present disclosure provide methods and apparatus for excluding a measurement gap duration from an inactivity timer period. An example method generally includes maintaining an inactivity timer used to track a number of time intervals during which no downlink transmission is received by the UE; and excluding time intervals occurring during a measurement gap when updating the inactivity timer.

### CROSS-REFERENCE TO RELATED APPLICATIONS

This application claims benefit of U.S. Provisional Patent Application Ser. No. 62/161,161, entitled “Excluding the Measurement Gap Duration From an Inactivity Timer Period,” filed May 13, 2015, and assigned to the assignee hereof, the contents of which are hereby incorporated by reference.

### BACKGROUND

1. Field of the Invention

Certain aspects of the present disclosure generally relate to wireless communications and, more particularly, to maintaining inactivity timers in a wireless system, for example, excluding the measurement gap duration from an inactivity timer period.

2. Relevant Background

Wireless communication networks are widely deployed to provide various communication services such as voice, video, packet data, messaging, broadcast, etc. These wireless networks may be multiple-access networks capable of supporting multiple users by sharing the available network resources. Examples of such multiple-access networks include Code Division Multiple Access (CDMA) networks, Time Division Multiple Access (TDMA) networks, Frequency Division Multiple Access (FDMA) networks, Orthogonal FDMA (OFDMA) networks, and Single-Carrier FDMA (SC-FDMA) networks.

### SUMMARY

Certain aspects of the present disclosure provide a method for wireless communications by a user equipment (UE), for example, excluding the measurement gap duration from an inactivity timer period. The method generally includes maintaining an inactivity timer used to track a number of time intervals during which no downlink transmission is received by the UE, and excluding time intervals occurring during a measurement gap when updating the inactivity timer.

Certain aspects of the present disclosure provide an apparatus for wireless communications by a user equipment (UE). The apparatus generally includes a receiver configured to monitor for downlink transmissions from a base station (BS), and a processor configured to maintain an inactivity timer used to track a number of time intervals during which no downlink transmission is received by the UE, and exclude time intervals occurring during a measurement gap when updating the inactivity timer.

Some aspects of the present disclosure provide an apparatus for wireless communications by a user equipment (UE). The apparatus generally includes means for maintaining an inactivity timer used to track a number of time intervals during which no downlink transmission is received by the UE, and means for excluding time intervals occurring during a measurement gap when updating the inactivity timer.

Certain aspects of the present disclosure provide a computer program product for wireless communications by a user equipment (UE) comprising a computer readable medium having instructions stored thereon. The instructions are generally executable for maintaining an inactivity timer used to track a number of time intervals during which no downlink transmission is received by the UE, and excluding time intervals occurring during a measurement gap when updating the inactivity timer.

### BRIEF DESCRIPTION OF THE DRAWINGS

So that the manner in which the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects.

FIG. 1 is a diagram illustrating an example of a network architecture, in accordance with certain aspects of the disclosure.

FIG. 2 is a diagram illustrating an example of an access network, in accordance with certain aspects of the disclosure.

FIG. 3 is a diagram illustrating an example of a DL frame structure in LTE, in accordance with certain aspects of the disclosure.

FIG. 4 is a diagram illustrating an example of an UL frame structure in LTE, in accordance with certain aspects of the disclosure.

FIG. 5 is a diagram illustrating an example of a radio protocol architecture for the user and control plane, in accordance with certain aspects of the disclosure.

FIG. 6 is a diagram illustrating an example of an evolved Node B and user equipment in an access network, in accordance with certain aspects of the disclosure.

FIG. 7 illustrates example operations that may be performed by a user equipment.

FIG. 8 illustrates an example process for excluding a measurement gap duration from an inactivity timer period, in accordance with certain aspects of the present disclosure.

FIG. 9 illustrates example operations that may be performed by a user equipment to exclude a measurement gap duration from an inactivity timer period, in accordance with certain aspects of the present disclosure.

FIG. 10 illustrates example operations that may be performed by a user equipment to pause and resume or reset an inactivity timer after excluding a measurement gap duration from the inactivity timer period, in accordance with certain aspects of the present disclosure.

### DETAILED DESCRIPTION

Aspects of the present disclosure provide techniques and apparatus for maintaining an inactivity timer based on a measurement gap duration. The inactivity timer may be paused during a measurement or tune away gap in which the UE discontinues activity on a current serving cell and tunes to other frequencies and/or other radio access technology (RAT) networks to perform network measurements on other cells and/or RAT networks. In aspects, the inactivity timer may be resumed after the measurement gap.

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Several aspects of telecommunication systems will now be presented with reference to various apparatus and methods. These apparatus and methods will be described in the following detailed description and illustrated in the accompanying drawings by various blocks, modules, components, circuits, steps, processes, algorithms, etc. (collectively referred to as “elements”). These elements may be implemented using hardware, software, or combinations thereof Whether such elements are implemented as hardware or software depends upon the particular application and design constraints imposed on the overall system.

By way of example, an element, or any portion of an element, or any combination of elements may be implemented with a “processing system” that includes one or more processors. Examples of processors include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software modules, applications, software applications, software packages, firmware, routines, subroutines, objects, executables, threads of execution, procedures, functions, etc., whether referred to as software/firmware, middleware, microcode, hardware description language, or otherwise.

Accordingly, in one or more exemplary embodiments, the functions described may be implemented in hardware, software, or combinations thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise RAM, ROM, EEPROM, PCM (phase change memory), flash memory, CD-ROM or other optical disk storage, magnetic disk storage or other magnetic storage devices, or any other medium that can be used to carry or store desired program code in the form of instructions or data structures and that can be accessed by a computer. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media.

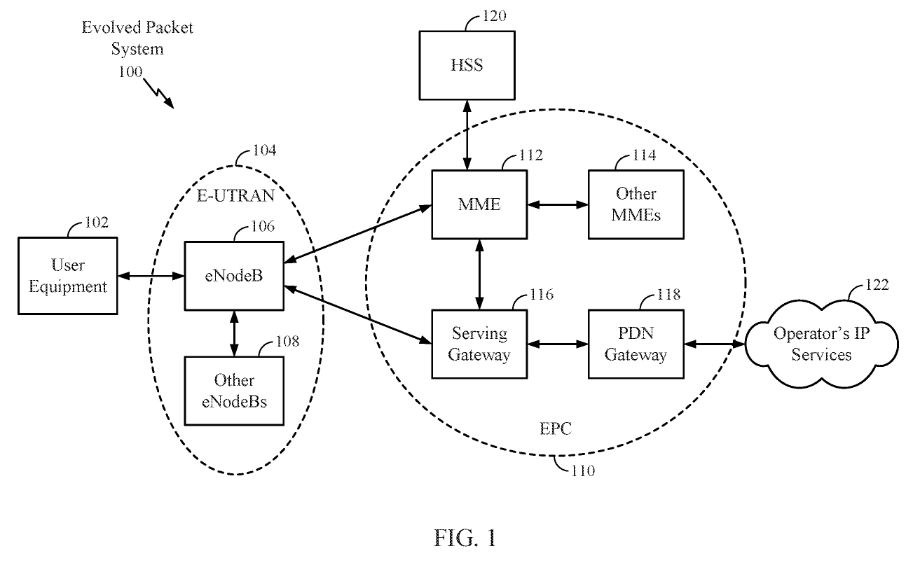

FIG. 1 is a diagram illustrating a network architecture 100 in which aspects of the present disclosure may be practiced. For example, UE 102 may be configured to maintain an inactivity timer by excluding the measurement gap duration from the inactivity timer period as described herein.

In aspects, the network architecture may be an LTE network architecture 100, which may be referred to as an Evolved Packet System (EPS). The EPS may include one or more user equipment (UE) 102, an Evolved UMTS Terrestrial Radio Access Network (E-UTRAN) 104, an Evolved Packet Core (EPC) 110, a Home Subscriber Server (HSS) 120, and an Operator's IP Services 122. The EPS can interconnect with other access networks, but for simplicity those entities/interfaces are not shown. Exemplary other access networks may include an IP Multimedia Subsystem (IMS) PDN, Internet PDN, Administrative PDN (e.g., Provisioning PDN), carrier-specific PDN, operator-specific PDN, and/or GPS PDN. “LTE” refers generally to LTE and LTE-Advanced (LTE-A). As shown, the EPS provides packet-switched services, however, as those skilled in the art will readily appreciate, the various concepts presented throughout this disclosure may be extended to networks providing circuit-switched services.

The E-UTRAN includes the evolved Node B (eNB) 106 and other eNBs 108. The eNB 106 provides user and control plane protocol terminations toward the UE 102. The eNB 106 may be connected to the other eNBs 108 via an X2 interface (e.g., backhaul). The eNB 106 may also be referred to as a base station, a base transceiver station, a radio base station, a radio transceiver, a transceiver function, a basic service set (BSS), an extended service set (ESS), an access point, or some other suitable terminology. The eNB 106 may provide an access point to the EPC 110 for a UE 102. Examples of UEs 102 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a netbook, a smart book, an ultrabook, or any other similar functioning device. The UE 102 may also be referred to by those skilled in the art as a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology.

The eNB 106 is connected by an 51 interface to the EPC 110. The EPC 110 includes a Mobility Management Entity (MME) 112, other MMEs 114, a Serving Gateway 116, and/or a Packet Data Network (PDN) Gateway 118. The MME 112 is the control node that processes the signaling between the UE 102 and the EPC 110. Generally, the MME 112 provides bearer and connection management. All user IP packets are transferred through the Serving Gateway 116, which itself is connected to the PDN Gateway 118. The PDN Gateway 118 provides UE IP address allocation as well as other functions. The PDN Gateway 118 is connected to the Operator's IP Services 122. The Operator's IP Services 122 may include, for example, the Internet, the Intranet, an IP Multimedia Subsystem (IMS), and a PS (packet-switched) Streaming Service (PSS). In this manner, the UE 102 may be coupled to the PDN through the LTE network. In aspects, the network architecture 100 may include another radio access network (RAN). In general, any number of wireless networks may be deployed in a given geographic area. Each wireless network may support a particular RAT and may operate on one or more frequencies. A RAT may also be referred to as a radio technology, an air interface, etc. A frequency or frequency ranges may also be referred to as a carrier, a frequency channel, a radio channel, or the like. Each frequency or frequency range may support a single RAT in a given geographic area in order to avoid interference between wireless networks of different RATs. A radio channel may be identified by a radio channel identifier, such as a frequency identifier (e.g., an absolute radio frequency channel number (ARFCN), an evolved ARFCN (EARFCN), etc.), a cell identifier (e.g., a physical cell identifier (PCI), a base station identity code (BSIC), etc.), or the like.

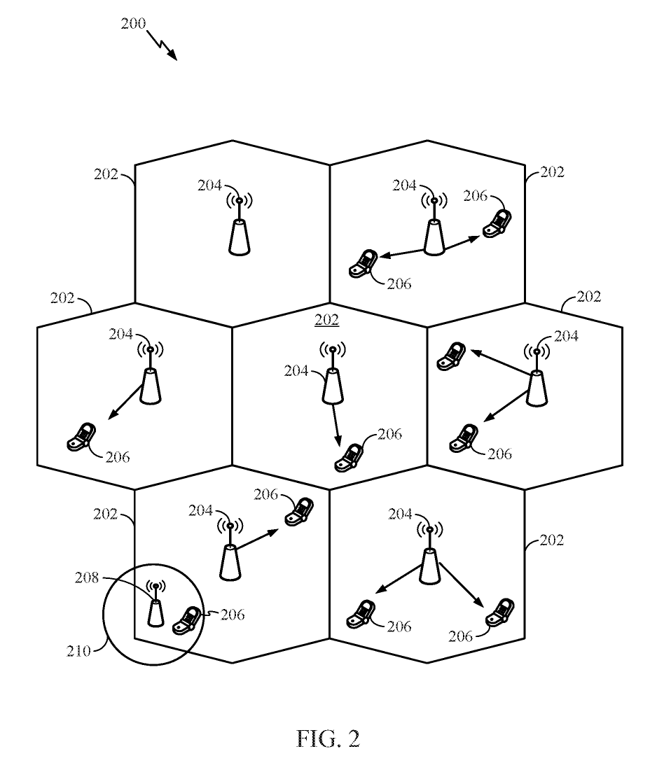

FIG. 2 is a diagram illustrating an example of an access network 200 in an LTE network architecture, in accordance with certain aspects of the disclosure. Aspects of the present disclosure may be practiced in the exemplary access network 200. For example, one or more of the UEs 206 may be configured to maintain an inactivity timer by excluding the measurement gap duration from the inactivity timer period as described herein.

In this example, the access network 200 is divided into a number of cellular regions (cells) 202. One or more lower power class eNBs 208 may have cellular regions 210 that overlap with one or more of the cells 202. A lower power class eNB 208 may be referred to as a remote radio head (RRH). The lower power class eNB 208 may be a femto cell (e.g., home eNB (HeNB)), pico cell, or micro cell. The macro eNBs 204 are each assigned to a respective cell 202 and are configured to provide an access point to the EPC 110 for all the UEs 206 in the cells 202. There is no centralized controller in this example of an access network 200, but a centralized controller may be used in alternative configurations. The eNBs 204 are responsible for all radio related functions including radio bearer control, admission control, mobility control, scheduling, security, and connectivity to the serving gateway 116. The network 200 may also include one or more relays (not shown). According to one application, a UE may serve as a relay.

The modulation and multiple access scheme employed by the access network 200 may vary depending on the particular telecommunications standard being deployed. In LTE applications, OFDM is used on the DL and SC-FDMA is used on the UL to support both frequency division duplexing (FDD) and time division duplexing (TDD). As those skilled in the art will readily appreciate from the detailed description to follow, the various concepts presented herein are well suited for LTE applications. However, these concepts may be readily extended to other telecommunication standards employing other modulation and multiple access techniques. By way of example, these concepts may be extended to Evolution-Data Optimized (EV-DO) or Ultra Mobile Broadband (UMB). EV-DO and UMB are air interface standards promulgated by the 3rd Generation Partnership Project 2 (3GPP2) as part of the CDMA2000 family of standards and employ CDMA to provide broadband Internet access to mobile stations. These concepts may also be extended to Universal Terrestrial Radio Access (UTRA) employing Wideband-CDMA (W-CDMA) and other variants of CDMA, such as TD-SCDMA; Global System for Mobile Communications (GSM) employing TDMA; and Evolved UTRA (E-UTRA), Ultra Mobile Broadband (UMB), IEEE 802.11 (Wi-Fi), IEEE 802.16 (WiMAX), IEEE 802.20, and Flash-OFDM employing OFDMA. UTRA, E-UTRA, UMTS, LTE and GSM are described in documents from the 3GPP organization. CDMA2000 and UMB are described in documents from the 3GPP2 organization. The actual wireless communication standard and the multiple access technology employed will depend on the specific application and the overall design constraints imposed on the system.

The eNBs 204 may have multiple antennas supporting MIMO technology. The use of MIMO technology enables the eNBs 204 to exploit the spatial domain to support spatial multiplexing, beamforming, and transmit diversity. Spatial multiplexing may be used to transmit different streams of data simultaneously on the same frequency. The data streams may be transmitted to a single UE 206 to increase the data rate or to multiple UEs 206 to increase the overall system capacity. This is achieved by spatially precoding each data stream (e.g., applying a scaling of an amplitude and a phase) and then transmitting each spatially precoded stream through multiple transmit antennas on the DL. The spatially precoded data streams arrive at the UE(s) 206 with different spatial signatures, which enables each of the UE(s) 206 to recover the one or more data streams destined for that UE 206. On the UL, each UE 206 transmits a spatially precoded data stream, which enables the eNB 204 to identify the source of each spatially precoded data stream.

Spatial multiplexing is generally used when channel conditions are good. When channel conditions are less favorable, beamforming may be used to focus the transmission energy in one or more directions. This may be achieved by spatially precoding the data for transmission through multiple antennas. To achieve good coverage at the edges of the cell, a single stream beamforming transmission may be used in combination with transmit diversity.

In the detailed description that follows, various aspects of an access network will be described with reference to a MIMO system supporting OFDM on the DL. OFDM is a spread-spectrum technique that modulates data over a number of subcarriers within an OFDM symbol. The subcarriers are spaced apart at precise frequencies. The spacing provides “orthogonality” that enables a receiver to recover the data from the subcarriers. In the time domain, a guard interval (e.g., cyclic prefix) may be added to each OFDM symbol to combat inter-OFDM-symbol interference. The UL may use SC-FDMA in the form of a DFT-spread OFDM signal to compensate for high peak-to-average power ratio (PAPR).

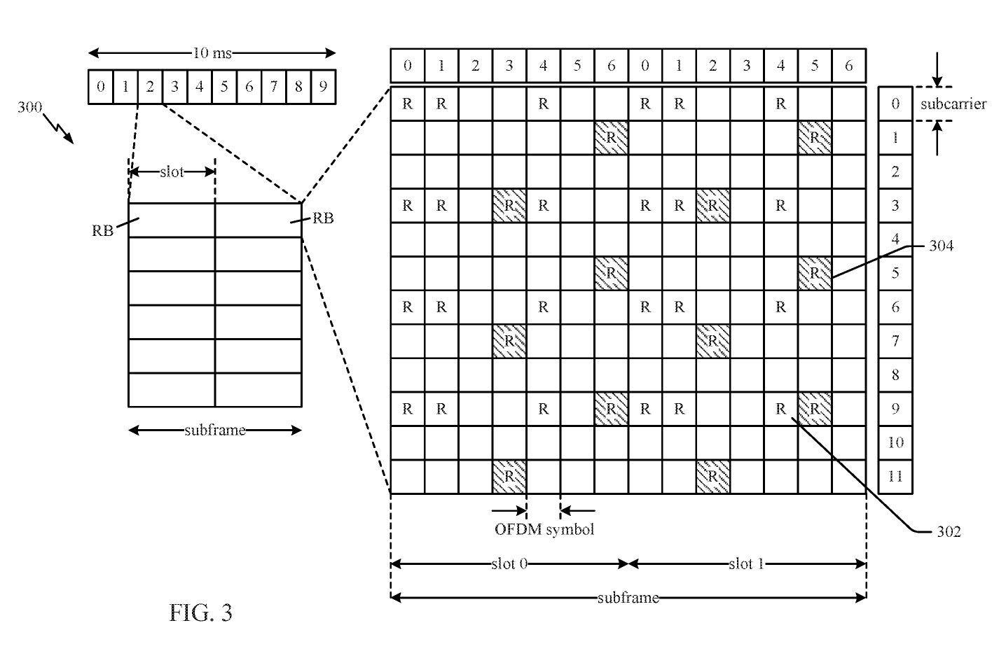

FIG. 3 is a diagram 300 illustrating an example of a DL frame structure in LTE, which may be used with the network architecture 100 shown in FIG. 1 and the access network 200 shown in FIG. 2, in accordance with certain aspects of the disclosure. A frame (10 ms) may be divided into 10 equally sized sub-frames with indices of 0 through 9. Each sub-frame may include two consecutive time slots. A resource grid may be used to represent two time slots, each time slot including a resource block. The resource grid is divided into multiple resource elements. In LTE, a resource block contains 12 consecutive subcarriers in the frequency domain and, for a normal cyclic prefix in each OFDM symbol, 7 consecutive OFDM symbols in the time domain, or 84 resource elements. For an extended cyclic prefix, a resource block contains 6 consecutive OFDM symbols in the time domain and has 72 resource elements. Some of the resource elements, as indicated as R 302, R 304, include DL reference signals (DL-RS). The DL-RS include Cell-specific RS (CRS) (also sometimes called common RS) 302 and UE-specific RS (UE-RS) 304. UE-RS 304 are transmitted only on the resource blocks upon which the corresponding physical DL shared channel (PDSCH) is mapped. The number of bits carried by each resource element depends on the modulation scheme. Thus, the more resource blocks that a UE receives and the higher the modulation scheme, the higher the data rate for the UE.

In LTE, an eNB may send a primary synchronization signal (PSS) and a secondary synchronization signal (SSS) for each cell served by the eNB. The primary and secondary synchronization signals may be sent in symbol periods 6 and 5, respectively, in each of subframes 0 and 5 of each radio frame with the normal cyclic prefix (CP). The synchronization signals may be used by UEs for cell detection and acquisition. The eNB may send a Physical Broadcast Channel (PBCH) in symbol periods 0 to 3 in slot 1 of subframe 0. The PBCH may carry certain system information.

The eNB may send a Physical Control Format Indicator Channel (PCFICH) in the first symbol period of each subframe. The PCFICH may convey the number of symbol periods (M) used for control channels, where M may be equal to 1, 2 or 3 and may change from subframe to subframe. M may also be equal to 4 for a small system bandwidth, e.g., with less than 10 resource blocks. The eNB may send a Physical HARQ Indicator Channel (PHICH) and a Physical Downlink Control Channel (PDCCH) in the first M symbol periods of each subframe. The PHICH may carry information to support hybrid automatic repeat request (HARQ). The PDCCH may carry information on resource allocation for UEs and control information for downlink channels. The eNB may send a Physical Downlink Shared Channel (PDSCH) in the remaining symbol periods of each subframe. The PDSCH may carry data for UEs scheduled for data transmission on the downlink.

The eNB may send the PSS, SSS, and PBCH in the center 1.08 MHz of the system bandwidth used by the eNB. The eNB may send the PCFICH and PHICH across the entire system bandwidth in each symbol period in which these channels are sent. The eNB may send the PDCCH to groups of UEs in certain portions of the system bandwidth. The eNB may send the PDSCH to specific UEs in specific portions of the system bandwidth. The eNB may send the PSS, SSS, PBCH, PCFICH, and PHICH in a broadcast manner to all UEs, may send the PDCCH in a unicast manner to specific UEs, and may also send the PDSCH in a unicast manner to specific UEs.

A number of resource elements may be available in each symbol period. Each resource element (RE) may cover one subcarrier in one symbol period and may be used to send one modulation symbol, which may be a real or complex value. Resource elements not used for a reference signal in each symbol period may be arranged into resource element groups (REGs). Each REG may include four resource elements in one symbol period. The PCFICH may occupy four REGs, which may be spaced approximately equally across frequency, in symbol period 0. The PHICH may occupy three REGs, which may be spread across frequency, in one or more configurable symbol periods. For example, the three REGs for the PHICH may all belong in symbol period 0 or may be spread in symbol periods 0, 1, and 2. The PDCCH may occupy 9, 18, 36, or 72 REGs, which may be selected from the available REGs, in the first M symbol periods, for example. Only certain combinations of REGs may be allowed for the PDCCH. In aspects of the present methods and apparatus, a subframe may include more than one PDCCH.

A UE may know the specific REGs used for the PHICH and the PCFICH. The UE may search different combinations of REGs for the PDCCH. The number of combinations to search is typically less than the number of allowed combinations for the PDCCH. An eNB may send the PDCCH to the UE in any of the combinations that the UE will search.

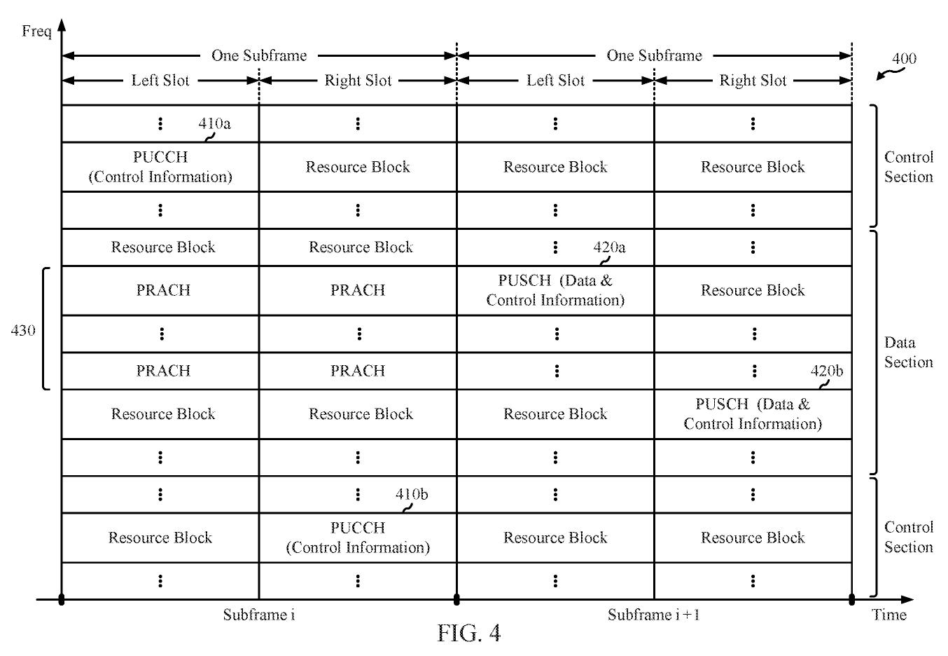

FIG. 4 is a diagram 400 illustrating an example of an UL frame structure in LTE, in accordance with certain aspects of the disclosure. The exemplary UL frame structure may be used with the network architecture 100 shown in FIG. 1 and the access network 200 shown in FIG. 2. The available resource blocks for the UL may be partitioned into a data section and a control section. The control section may be formed at the two edges of the system bandwidth and may have a configurable size. The resource blocks in the control section may be assigned to UEs for transmission of control information. The data section may include all resource blocks not included in the control section. The UL frame structure results in the data section including contiguous subcarriers, which may allow a single UE to be assigned all of the contiguous subcarriers in the data section.

A UE may be assigned resource blocks 410a, 410b in the control section to transmit control information to an eNB. The UE may also be assigned resource blocks 420a, 420b in the data section to transmit data to the eNB. The UE may transmit control information in a physical UL control channel (PUCCH) on the assigned resource blocks in the control section. The UE may transmit only data or both data and control information in a physical UL shared channel (PUSCH) on the assigned resource blocks in the data section. A UL transmission may span both slots of a subframe and may hop across frequency.

A set of resource blocks may be used to perform initial system access and achieve UL synchronization in a physical random access channel (PRACH) 430. The PRACH 430 carries a random sequence and cannot carry any UL data/signaling. Each random access preamble occupies a bandwidth corresponding to six consecutive resource blocks. The starting frequency is specified by the network. That is, the transmission of the random access preamble is restricted to certain time and frequency resources. There is no frequency hopping for the PRACH. The PRACH attempt is carried in a single subframe (1 ms) or in a sequence of few contiguous subframes and a UE can make only a single PRACH attempt per frame (10 ms).

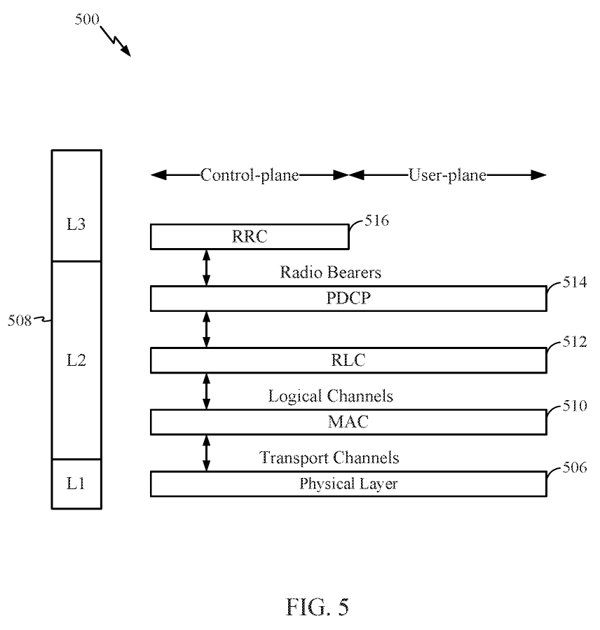

FIG. 5 is a diagram 500 illustrating an example of a radio protocol architecture for the user and control planes in LTE, in accordance with certain aspects of the disclosure. The illustrated radio protocol architecture may be used with the network architecture 100 shown in FIG. 1 and the access network 200 shown in FIG. 2. Data for wireless transmission by a device (e.g., a UE, an eNB) arrives from higher layers and is processed by the various layers as they pass the data down, until it is transmitted by the lowest layer, Layer 1 (L1) 506. Processing of the data may include dividing it into packets and adding error-checking information (e.g., checksums). Data is received (e.g., over radio waves) by L1, and passed up through and processed by the higher layers. Various sublayer functions, such as the RLC sublayer, may send acknowledgments (ACKs) of received data and accept ACKs of transmitted data. When a sublayer does not receive an ACK of transmitted data, the sublayer may trigger retransmission of the data. That is, the sublayer may send the same data (e.g., data packets) to lower layers to cause the lower layers to retransmit the data.

L1 is the lowest layer of the radio protocol architecture for the UE and the ENB and implements various physical layer signal processing functions. The L1 layer will be referred to herein as the physical layer (PHY). Layer 2 (L2 layer) 508 is above the physical layer 506 and is responsible for the link between the UE and eNB over the physical layer 506.

In the user plane, the L2 layer 508 includes a media access control (MAC) sublayer 510, a radio link control (RLC) sublayer 512, and a packet data convergence protocol (PDCP) 514 sublayer, which are terminated at the eNB on the network side. Although not shown, the UE may have several upper layers above the L2 layer 508 including a network layer (e.g., IP layer) that is terminated at the PDN gateway 118 on the network side, and an application layer that is terminated at the other end of the connection (e.g., far end UE, server, etc.).

The PDCP sublayer 514 provides multiplexing between different radio bearers and logical channels. The PDCP sublayer 514 also provides header compression for upper layer data packets to reduce radio transmission overhead, security by ciphering the data packets, and handover support for UEs between eNBs. The RLC sublayer 512 provides segmentation and reassembly of upper layer data packets, retransmission of lost data packets, and reordering of data packets to compensate for out-of-order reception due to hybrid automatic repeat request (HARQ) operations. The MAC sublayer 510 provides multiplexing between logical and transport channels. The MAC sublayer 510 is also responsible for allocating the various radio resources (e.g., resource blocks) in one cell among the UEs. The MAC sublayer 510 is also responsible for HARQ operations.

In the control plane, the radio protocol architecture for the UE and eNB is substantially the same for the physical layer 506 and the L2 layer 508 with the exception that there is no header compression function for the control plane. The control plane also includes a radio resource control (RRC) sublayer 516 in Layer 3 (L3 layer). The RRC sublayer 516 is responsible for obtaining radio resources (i.e., radio bearers) and for configuring the lower layers using RRC signaling between the eNB and the UE.

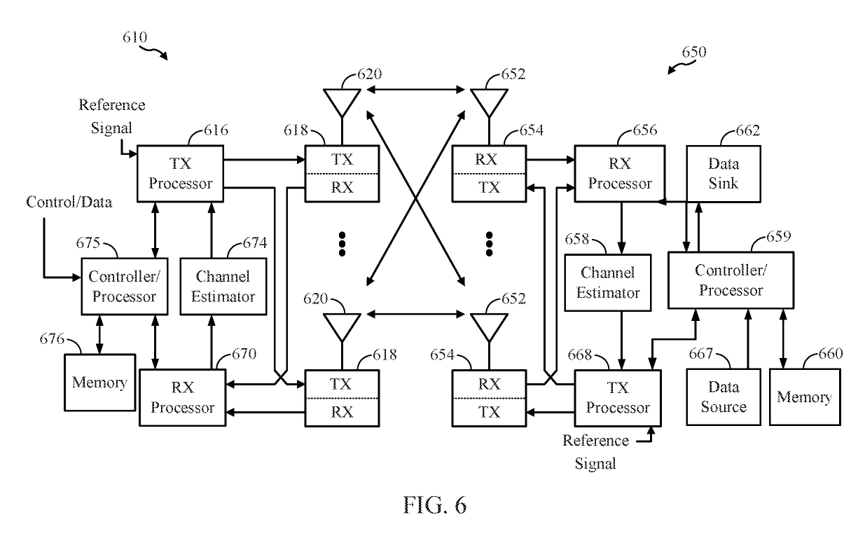

FIG. 6 is a block diagram of an eNB 610 in communication with a UE 650 in an access network, in accordance with certain aspects of the disclosure. The access network may be similar to the access network 200 shown in FIG. 2, and may utilize the network architecture 100 shown in FIG. 1. Aspects of the present disclosure may be practiced in the UE 650.

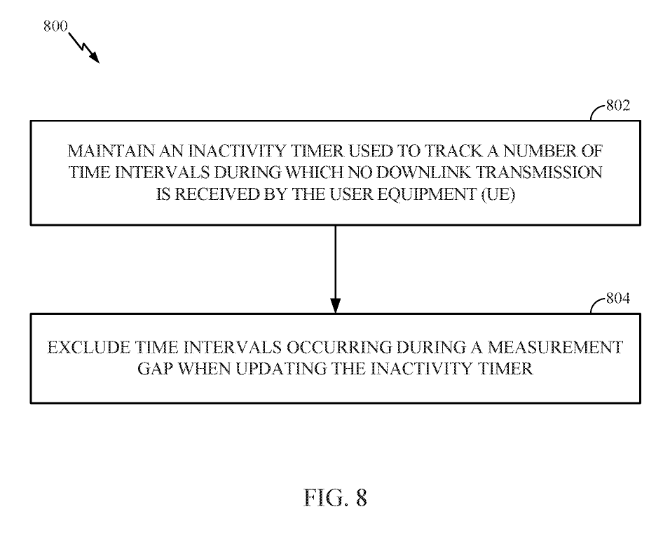

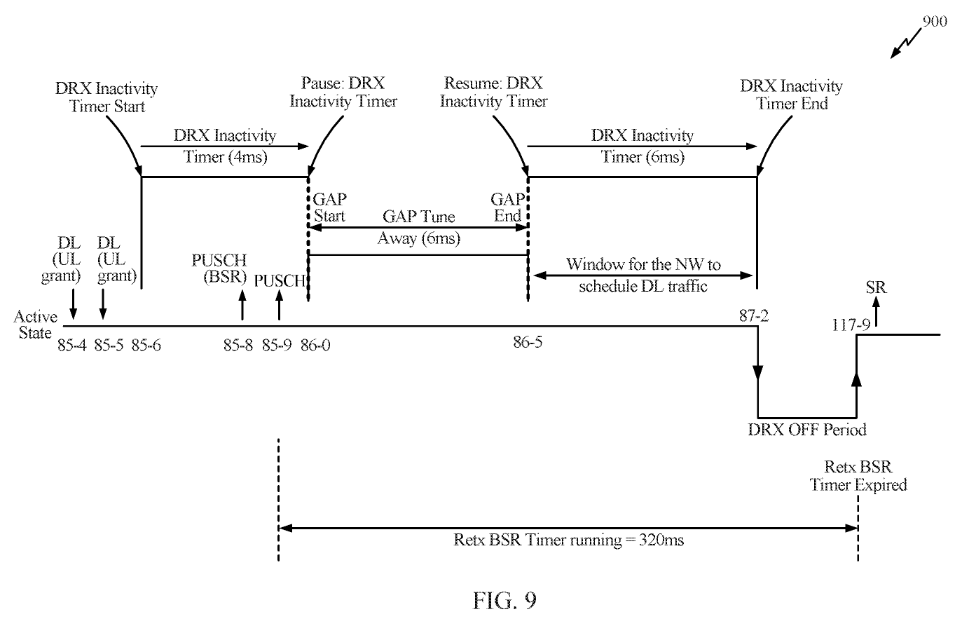

For example, the UE 650 may be configured to maintain an inactivity timer by excluding the measurement gap duration from the inactivity timer period, as described below with reference to FIG. 8 and FIG. 9.

In the DL, upper layer packets from the core network are provided to a controller/processor 675. The controller/processor 675 implements the functionality of the L2 layer. In the DL, the controller/processor 675 provides header compression, ciphering, packet segmentation and reordering, multiplexing between logical and transport channels, and radio resource allocations to the UE 650 based on various priority metrics. The controller/processor 675 is also responsible for HARQ operations, retransmission of lost packets, and signaling to the UE 650.

The TX processor 616 implements various signal processing functions for the L1 layer (i.e., physical layer). The signal processing functions includes coding and interleaving to facilitate forward error correction (FEC) at the UE 650 and mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols are then split into parallel streams. Each stream is then mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 674 may be used to determine the coding and modulation scheme, as well as for spatial processing. The channel estimate may be derived from a reference signal and/or channel condition feedback transmitted by the UE 650. Each spatial stream is then provided to a different antenna 620 via a separate transmitter 618TX. Each transmitter 618TX modulates an RF carrier with a respective spatial stream for transmission.

At the UE 650, each receiver 654RX receives a signal through its respective antenna 652. Each receiver 654RX recovers information modulated onto an RF carrier and provides the information to the receiver (RX) processor 656. The RX processor 656 implements various signal processing functions of the L1 layer. The RX processor 656 may perform or direct the UE in performing aspects of the present disclosure for maintaining an inactivity timer by excluding the measurement gap duration from the inactivity timer period, such as the process or operations 800, 900 described below with reference to FIGS. 8-9. The RX processor 656 performs spatial processing on the information to recover any spatial streams destined for the UE 650. If multiple spatial streams are destined for the UE 650, they may be combined by the RX processor 656 into a single OFDM symbol stream. The RX processor 656 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, is recovered and demodulated by determining the most likely signal constellation points transmitted by the eNB 610. These soft decisions may be based on channel estimates computed by the channel estimator 658. The soft decisions are then decoded and deinterleaved to recover the data and control signals that were originally transmitted by the eNB 610 on the physical channel. The data and control signals are then provided to the controller/processor 659.

The controller/processor 659 implements the L2 layer. The controller/processor 659 may perform or direct the UE in performing aspects of the present disclosure for maintaining an inactivity timer by excluding the measurement gap duration from the inactivity timer period, such as the process or operations 800, 900 described below with reference to FIGS. 8-9. The controller/processor 659 can be associated with a memory 660 that stores program codes and data. The memory 660 may be referred to as a computer-readable medium. The memory 660 may store instructions for performing aspects of the present disclosure for directing the UE in performing aspects of the present disclosure, such as the process or operations 800, 900 described below with reference to FIGS. 8-9. In the UL, the control/processor 659 provides demultiplexing between transport and logical channels, packet reassembly, deciphering, header decompression, control signal processing to recover upper layer packets from the core network. The upper layer packets are then provided to a data sink 662, which represents all the protocol layers above the L2 layer. Various control signals may also be provided to the data sink 662 for L3 processing. The controller/processor 659 is also responsible for error detection using an acknowledgement (ACK) and/or negative acknowledgement (NACK) protocol to support HARQ operations.

In the UL, a data source 667 is used to provide upper layer packets to the controller/processor 659. The data source 667 represents all protocol layers above the L2 layer. Similar to the functionality described in connection with the DL transmission by the eNB 610, the controller/processor 659 implements the L2 layer for the user plane and the control plane by providing header compression, ciphering, packet segmentation and reordering, and multiplexing between logical and transport channels based on radio resource allocations by the eNB 610. The controller/processor 659 is also responsible for HARQ operations, retransmission of lost packets, and signaling to the eNB 610.

Channel estimates derived by a channel estimator 658 from a reference signal or feedback transmitted by the eNB 610 may be used by the TX processor 668 to select the appropriate coding and modulation schemes, and to facilitate spatial processing. The spatial streams generated by the TX processor 668 are provided to different antenna 652 via separate transmitters 654TX. Each transmitter 654TX modulates an RF carrier with a respective spatial stream for transmission.

The UL transmission is processed at the eNB 610 in a manner similar to that described in connection with the receiver function at the UE 650. Each receiver 618RX receives a signal through its respective antenna 620. Each receiver 618RX recovers information modulated onto an RF carrier and provides the information to a RX processor 670. The RX processor 670 may implement the L1 layer.

The controller/processor 675 implements the L2 layer. The controller/processor 675 can be associated with a memory 676 that stores program codes and data. The memory 676 may be referred to as a computer-readable medium. In the UL, the control/processor 675 provides demultiplexing between transport and logical channels, packet reassembly, deciphering, header decompression, control signal processing to recover upper layer packets from the UE 650. Upper layer packets from the controller/processor 675 may be provided to the core network. The controller/processor 675 is also responsible for error detection using an ACK and/or NACK protocol to support HARQ operations. The controllers/processors 675, 659 may direct the operation at the eNB 610 and the UE 650, respectively. The controller/processor 659 and/or other processors and modules at the UE 650 may perform or direct operations, for example process or operations 800, 900, 1000 in FIGS. 8-10, and/or other processes for the techniques described herein, for example. In aspects, one or more of any of the components shown in FIG. 6 may be employed to perform example process or operations 800, 900, 1000 and/or other processes for the techniques (e.g., maintaining an inactivity timer by excluding a measurement gap duration) described herein.

Example Excluding Measurement Gap Duration from an Inactivity Timer Period

Certain aspects of the present disclosure provide mechanisms for maintaining inactivity timers based on excluding a measurement gap duration from the inactivity timer period. Excluding the measurement gap duration from an inactivity timer may allow for a UE to utilize (e.g., fully utilize) the inactivity timer duration to monitor for downlink transmissions from an eNodeB.

Connected mode discontinuous reception (CDRX) may be used for downlink transmissions by a UE to save UE power. A UE may maintain an inactivity timer and monitor for downlink transmissions, for example, on the physical downlink control channel (PDCCH). The inactivity timer may correspond to a number of time intervals (e.g., number of transmission time intervals (TTIs) or number of subframes) in which the UE does not detect downlink transmissions from a serving eNodeB.

If the UE detects activity on PDCCH, the UE may reset the inactivity timer to a starting value (e.g., 0 for an incrementing timer, or a threshold value for a decrementing timer). If the inactivity timer expires, indicating that the UE has not detected downlink transmissions from the serving eNodeB for a threshold amount of time (e.g., for a number of time intervals), the UE may enter a discontinuous reception mode. When the UE enters a discontinuous reception mode, the UE may save power by alternating between an active state, in which the UE may receive data, for example, from the eNodeB, and a sleep state, in which the need not listen for transmissions from, for example, the eNodeB.

In some cases, a UE may use a measurement gap to perform measurements on cells on other frequencies or other RAT networks. To perform measurements on other frequencies or other RAT networks, a UE may tune away from its serving cell during the measurement gap.

Based on these measurements, a UE may generate a measurement report. After the UE finishes performing measurements on cells operating on other frequencies or other RAT networks, the UE may re-tune to the frequency of its serving cell and transmit the measurement report to the serving cell.

Because a UE may tune to other frequencies or RAT networks during the measurement gap, incrementing the inactivity timer during the measurement gap may result in the UE not efficiently or fully utilizing the inactivity timer. The duration of the inactivity timer may be reduced by the measurement gap (e.g., a portion of or the entire duration of the measurement gap).

In some cases, a UE may enter a deadlock situation from entering into a discontinuous reception mode when an inactivity timer and measurement gap overlap. While the UE is in a deadlock situation, the UE may be unable to transmit and/or receive data even though the entirety of the inactivity time period was not used before the UE entered a discontinuous reception mode.

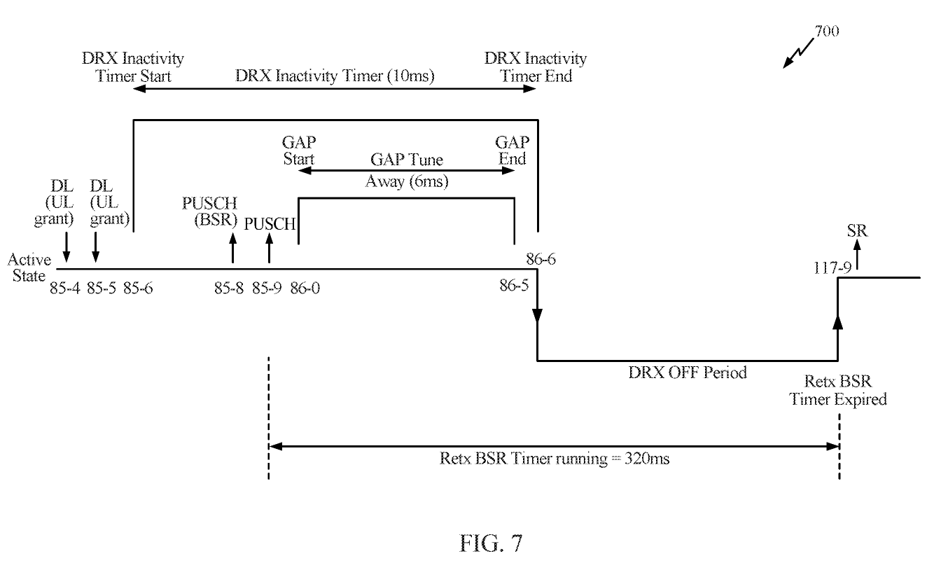

For example, as illustrated in FIG. 7, this deadlock situation may occur when a UE performs an uplink transmission with a buffer status report (BSR) while the inactivity timer is running and later enters a measurement gap period. If the inactivity timer continues to run during the measurement gap period, the UE may not be able to detect any downlink transmission in response to the BSR before the UE enters a discontinuous reception mode.

As illustrated in FIG. 7, the UE may begin an inactivity timer when the UE does not receive any downlink traffic during a given time period. For example, as illustrated, the UE receives downlink traffic at time intervals 85-4 and 85-5 but does not receive downlink traffic (e.g., from a serving eNodeB) at time period 85-6. Because the UE did not receive downlink traffic during time period 85-6, the UE may begin an inactivity timer.

At time period 85-8, the UE performs an uplink transmission with a buffer status report (e.g., on the physical uplink shared channel (PUSCH)), and at time period 86-0, the UE enters a measurement gap period. The measurement gap period runs concurrently with the inactivity timer, which may effectively reduce the duration of the inactivity timer by the duration of the measurement gap.

As illustrated, the measurement gap ends at time period 86-5, while the inactivity timer ends at time period 86-6. Thus, for a 10 ms inactivity timer and a 6 ms measurement gap period, the inactivity timer actually is only used to monitor for downlink transmissions from a serving eNodeB for 4 ms rather than the entire 10 ms duration of the inactivity timer.

In this case, the UE may remain in a discontinuous reception off period of a discontinuous reception cycle, which may prevent a serving eNodeB from transmitting downlink traffic (e.g., including an uplink grant) to the UE during the discontinuous reception off period. Since the UE may not receive an uplink grant, the UE may not be able to perform uplink transmissions or a service request until after a retransmission timer associated with the BSR expires.

FIG. 8 illustrates example operations 800 that may be performed to exclude a measurement gap duration from an inactivity timer, according to certain aspects of the present disclosure.

Operations 800 begin at 802, where the UE maintains an inactivity timer used to track a number of time intervals (e.g., number of transmission time intervals (TTIs) or number of subframes) during which no downlink transmission is received by the UE.

As discussed above, a UE may monitor a downlink channel (e.g., PDCCH) for transmissions from a serving eNodeB. If the UE detects activity on a downlink channel from a serving eNodeB during a time interval, the UE may reset the inactivity timer to a starting value (e.g., 0 for an incrementing timer, or a threshold value for a decrementing timer). If the UE does not detect activity on a downlink channel during a time interval, the UE may adjust the inactivity timer to move the inactivity timer closer to an expiry time.

At 804, the UE excludes time intervals occurring during a measurement gap when updating the inactivity timer. In some cases, a measurement gap may begin while a UE has not received a downlink transmission from the serving eNodeB for a number of time intervals. When a measurement gap begins, a UE may pause the inactivity timer at the beginning of the measurement gap, and resume the inactivity timer when the measurement gap ends.

FIG. 9 illustrates example operations that may be performed by a UE to maintain an inactivity timer by excluding time intervals occurring during a measurement gap when updating the inactivity timer, according to aspects of the present disclosure.

As illustrated, an inactivity timer (in this example, with a maximum duration of 10 milliseconds) may begin at time interval 85-6, and a measurement gap may begin at time interval 86-0. The UE may pause the inactivity timer at 86-0, with four milliseconds elapsed. After the measurement gap finishes at time interval 86-5, the UE may resume the inactivity timer for the remaining duration of the inactivity timer (in this example, the remaining six milliseconds of the timer). In aspects, the measurement gap may be 5 or 6 ms, for example.

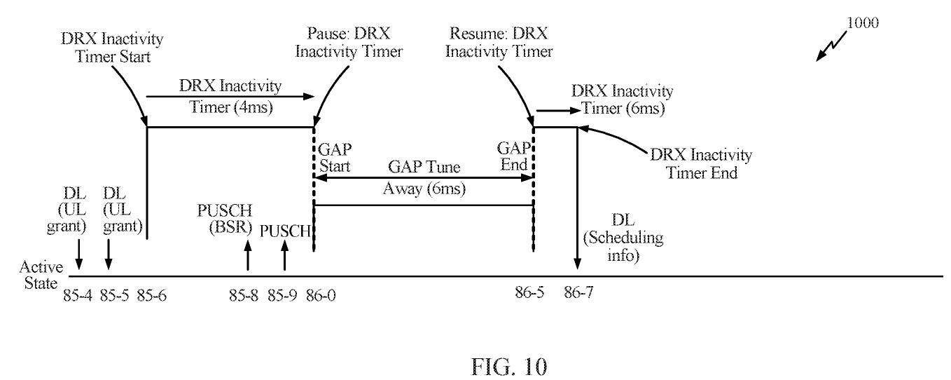

FIG. 10 illustrates example operations that may be performed by a UE to maintain an inactivity timer by excluding time intervals occurring during a measurement gap and pausing and resuming or resetting the inactivity timer on receipt of downlink transmissions, according to aspects of the present disclosure.

As illustrated, an inactivity timer may begin at time interval 85-6 and may be paused at time interval 86-0 when a measurement gap begins. The inactivity timer resumes at time interval 86-5, when the measurement gap ends.

During the remaining duration of the inactivity timer, the UE may receive a downlink transmission from the serving eNodeB (as illustrated at time interval 86-7), which may include scheduling information for downlink traffic and reset the inactivity timer. Thus, pausing the inactivity timer when the measurement gap begins and resuming the inactivity timer when the measurement gap ends may allow a UE to utilize the entire duration of an inactivity timer and avoid expiration of a BSR retransmission timer or entry into a discontinuous reception mode.

In some cases, the inactivity timer may have a configured time period. For example, the inactivity timer may be configured to expire when a UE does not receive downlink transmissions for 10 milliseconds (e.g., corresponding to 10 subframes). The UE may resume the inactivity timer for a remainder of the configured time period after a measurement gap ends. For example, as described above, if a measurement gap begins after four milliseconds have elapsed, the UE may resume the inactivity timer for the remaining six milliseconds after the measurement gap ends.

In some cases, a UE may receive a downlink transmission during the remainder of the configured time period. When the UE receives a downlink transmission during the remainder of the configured time period, the UE may reset the inactivity timer, which may prevent the UE from entering a discontinuous reception mode. In some cases, the downlink transmission may include a resource grant (e.g., in response to a BSR transmitted by the UE), which may allow for a continuation of uplink traffic from the UE. In this manner, expiration of a buffer status report retransmission timer may be avoided.

If the inactivity timer expires, the UE may enter a discontinuous reception mode. In some cases, the UE may enter a discontinuous reception off period if the inactivity timer expires.

It is understood that the specific order or hierarchy of steps in the processes disclosed is an illustration of exemplary approaches. Based upon design preferences, it is understood that the specific order or hierarchy of steps in the processes may be rearranged. Further, some steps may be combined or omitted. The accompanying method claims present elements of the various steps in a sample order, and are not meant to be limited to the specific order or hierarchy presented.

Moreover, the term “or” is intended to mean an inclusive “or” rather than an exclusive “or.” That is, unless specified otherwise or clear from the context, the phrase, for example, “X employs A or B” is intended to mean any of the natural inclusive permutations. That is, for example the phrase “X employs A or B” is satisfied by any of the following instances: X employs A; X employs B; or X employs both A and B. In addition, the articles “a” and “an” as used in this application and the appended claims should generally be construed to mean “one or more” unless specified otherwise or clear from the context to be directed to a singular form. A phrase referring to “at least one of” a list of items refers to any combination of those items, including single members. As an example, “at least one of: a, b, or c” is intended to cover: a, b, c, a-b, a-c, b-c, and a b c , as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Unless specifically stated otherwise, the term “some” refers to one or more. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed as a means plus function unless the element is expressly recited using the phrase “means for.”

What is claimed is:

1. A method for wireless communications by a user equipment (UE), comprising:
maintaining an inactivity timer used to track a number of time intervals during which no downlink transmission is received by the UE; and
excluding time intervals occurring during a measurement gap when updating the inactivity timer.

2. The method of claim 1, wherein the excluding comprises:
pausing the inactivity timer at a beginning of the measurement gap; and
resuming the inactivity timer when the measurement gap ends.

3. The method of claim 2, wherein resuming the inactivity timer when the measurement gap ends includes at least one of avoiding expiration of a buffer status report retransmission timer or avoiding entering a discontinuous reception mode.

4. The method of claim 2, wherein:
the inactivity timer has a configured time period; and
resuming the inactivity timer comprises resuming the inactivity timer for a remainder of the configured time period.

5. The method of claim 4, further comprising receiving a downlink transmission during the remainder of the configured time period.

6. The method of claim 5, wherein receiving a downlink transmission during the remainder of the configured time period includes receiving a resource grant during the remainder of the configured time period.

7. The method of claim 1, further comprising:
entering a discontinuous reception cycle if the inactivity timer expires.

8. The method of claim 7, wherein entering the discontinuous reception cycle if the inactivity timer expires includes entering a discontinuous reception off period if the inactivity timer expires.

9. An apparatus for wireless communications by a user equipment (UE), comprising:
a transceiver; and
a processor configured to:
maintain an inactivity timer used to track a number of time intervals during which no downlink transmission is received by the UE via the transceiver; and
exclude time intervals occurring during a measurement gap when updating the inactivity timer.

10. The apparatus of claim 9, wherein the processor is configured to exclude time intervals occurring during a measurement gap when updating the inactivity timer by:
pausing the inactivity timer at a beginning of the measurement gap; and
resuming the inactivity timer when the measurement gap ends.

11. The apparatus of claim 10, wherein resuming the inactivity timer when the measurement gap ends includes at least one of avoiding expiration of a buffer status report retransmission timer or avoiding entering a discontinuous reception mode.

12. The apparatus of claim 10, wherein:
the inactivity timer has a configured time period; and
resuming the inactivity timer comprises resuming the inactivity timer for a remainder of the configured time period.

13. The apparatus of claim 12, wherein the transceiver is configured to receive a downlink transmission during the remainder of the configured time period.

14. The apparatus of claim 13, wherein the downlink transmission received during the remainder of the configured time period includes a resource grant.

15. The apparatus of claim 9, wherein the processor is further configured to:
enter a discontinuous reception cycle if the inactivity timer expires.

16. The apparatus of claim 15, wherein the processor is further configured to: enter a discontinuous reception off period if the inactivity timer expires.

17. An apparatus for wireless communications, comprising:
means for maintaining an inactivity timer used to track a number of time intervals during which no downlink transmission is received by the UE; and
means for excluding time intervals occurring during a measurement gap when updating the inactivity timer.

18. The apparatus of claim 17, wherein the means for excluding comprises:
means for pausing the inactivity timer at a beginning of the measurement gap; and
means for resuming the inactivity timer when the measurement gap ends.

19. The apparatus of claim 18, wherein the means for resuming the inactivity timer when the measurement gap ends includes means for at least one of avoiding expiration of a buffer status report retransmission timer or avoiding entering a discontinuous reception mode.

20. The apparatus of claim 18, wherein:
the inactivity timer has a configured time period; and
the means for resuming the inactivity timer comprises means for resuming the inactivity timer for a remainder of the configured time period.

21. The apparatus of claim 20, further comprising:
means for receiving a downlink transmission during the remainder of the configured time period.

22. The apparatus of claim 21, wherein the means for receiving a downlink transmission during the remainder of the configured time period includes means for receiving a resource grant during the remainder of the configured time period.

23. The apparatus of claim 17, further comprising:
means for entering a discontinuous reception cycle if the inactivity timer expires.

24. The apparatus of claim 23, wherein the means for entering the discontinuous reception cycle if the inactivity timer expires includes means for entering a discontinuous off period if the inactivity timer expires.

25. A computer-readable medium for wireless communications by a user equipment (UE), comprising code which when executed by one or more processors, causes the UE to:
maintain an inactivity timer used to track a number of time intervals during which no downlink transmission is received by the UE; and
exclude time intervals occurring during a measurement gap when updating the inactivity timer.

26. The computer-readable medium of claim 25, wherein the code which when executed by one or more processors, causes the UE to exclude comprises code which when executed by one or more processors, causes the UE to:
pause the inactivity timer at a beginning of the measurement gap; and
resume the inactivity timer when the measurement gap ends.

27. The computer-readable medium of claim 26, wherein the code which when executed by one or more processors, causes the UE to resume the inactivity timer when the measurement gap ends includes code which when executed by one or more processors, causes the UE to at least one of avoid expiration of a buffer status report retransmission timer or avoid entering a discontinuous reception mode.

28. The computer-readable medium of claim 26, wherein:
the inactivity timer has a configured time period; and
the code which when executed by one or more processors, causes the UE to resume the inactivity timer comprises code which when executed by one or more processors, causes the UE to resume the inactivity timer for a remainder of the configured time period.

29. The computer-readable medium of claim 28, further comprising code which when executed by one or more processors, causes the UE to receive a downlink transmission during the remainder of the configured time period.

30. The computer-readable medium of claim 25, further comprising code which when executed by one or more processors, causes the UE to enter a discontinuous reception cycle if the inactivity timer expires.
